(19) United States
(12) Patent Application Publication
(10) Pub. No.: US 2013/0039101 A1
(43) Pub. Date: Feb. 14, 2013

(54) SWITCHING POWER SUPPLY APPARATUS

(71) Applicants: Hua-Ming Lu, Taoyuan County (TW); Kuo-Fan Lin, Taoyuan County (TW)

(72) Inventors: Hua-Ming Lu, Taoyuan County (TW); Kuo-Fan Lin, Taoyuan County (TW)

(73) Assignee: FSP TECHNOLOGY INC., Taoyuan County (TW)

(21) Appl. No.: 13/571,358

(22) Filed: Aug. 10, 2012

Related U.S. Application Data
(60) Provisional application No. 61/522,701, filed on Aug. 12, 2011.

(51) Int. Cl. H02M 1/36

(52) U.S. Cl. 363/49

(57) ABSTRACT

A switching power supply apparatus including an AC-to-DC conversion circuit, a hysteretic relay and a relay control circuit is provided. The AC-to-DC conversion circuit includes a current limit resistor, and the current limit resistor is configured to suppress an inrush current generated during the AC-to-DC conversion circuit converts an AC input voltage into a DC output voltage. The hysteretic relay is coupled with the current limit resistor in parallel. The relay control circuit is coupled to the AC-to-DC conversion circuit and the hysteretic relay, and configured to control the hysteretic relay to turn on in response to one of an over drive pulse signal and a holding modulation signal when the DC output voltage reaches to a predetermined value, so as to bypass the current limit resistor, wherein an enabling time of the over drive pulse signal is different from that of the holding modulation signal.

### CROSS-REFERENCE TO RELATED APPLICATION

This application claims the priority benefit of U.S. provisional application Ser. No. 61/522,701, filed Aug. 12, 2011. The entirety of the above-mentioned patent application is hereby incorporated by reference herein and made a part of this specification.

### BACKGROUND OF THE INVENTION

1. Field of the Invention

The present invention relates to a power supply apparatus, more particularly, to a switching power supply apparatus.

2. Description of the Related Art

In general, many capacitors with larger capacitance are configured within the switching power supply apparatus, resulting in that the extremely large inrush current is generated during the switching power supply apparatus is in the startup state. Accordingly, the subject of that how to suppress the startup inrush current is very important for a person skilled in the relevant art. In order to effectively suppress the startup inrush current, a current limit resistor for current limiting is basically configured on the flowing path of the inrush current, but the configured current limit resistor would generate unnecessary power loss during the switching power supply apparatus is in the normal operation state, and thus reducing or affecting the efficiency of the switching power supply apparatus.

### SUMMARY OF THE INVENTION

Accordingly, in order to solve the above-mentioned problem, an exemplary embodiment of the invention provides a switching power supply apparatus including an AC-to-DC conversion circuit, a hysteretic relay and a relay control circuit. The AC-to-DC conversion circuit includes a current limit resistor, and the current limit resistor is configured to suppress an inrush current generated during the AC-to-DC conversion circuit converts an AC input voltage into a DC output voltage. The hysteretic relay is coupled with the current limit resistor in parallel. The relay control circuit is coupled to the AC-to-DC conversion circuit and the hysteretic relay, and configured to control the hysteretic relay to turn on in response to one of an over drive pulse signal and a holding modulation signal when the DC output voltage reaches to a predetermined value, so as to bypass the current limit resistor, wherein an enabling time of the over drive pulse signal is different from that of the holding modulation signal. For example, the enabling time of the over drive pulse signal is substantially greater than that of the holding modulation signal.

In an exemplary embodiment of the invention, when the switching power supply apparatus is in the startup state, namely, the DC output voltage does not reach to the predetermined value, the inrush current generated during the AC-to-DC conversion circuit converts the AC input voltage into the DC output voltage is suppressed by the current limit resistor.

In an exemplary embodiment of the invention, when the switching power supply apparatus is in the normal operation state, namely, the DC output voltage reaches to the predetermined value, the over drive pulse signal with larger enabling time is generated by the relay control circuit to control the hysteretic relay to turn on, such that the current limit resistor is bypassed. Obviously, when the switching power supply apparatus is in the normal operation state, the current limit resistor would not generate unnecessary power loss, and then the efficiency of the switching power supply apparatus is improved or unaffected.

In an exemplary embodiment of the invention, after the current limit resistor is bypassed, the holding modulation signal with smaller enabling time is generated by the relay control circuit to control the hysteretic relay to continuously turn on, such that the power loss of the hysteretic relay in operation is reduced, and then the purpose of power-saving can be achieved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a switching power supply apparatus according to an exemplary embodiment of the invention.

FIG. 2 is a diagram of a driving module in FIG. 1.

FIG. 3 is a part of operation waveforms in FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

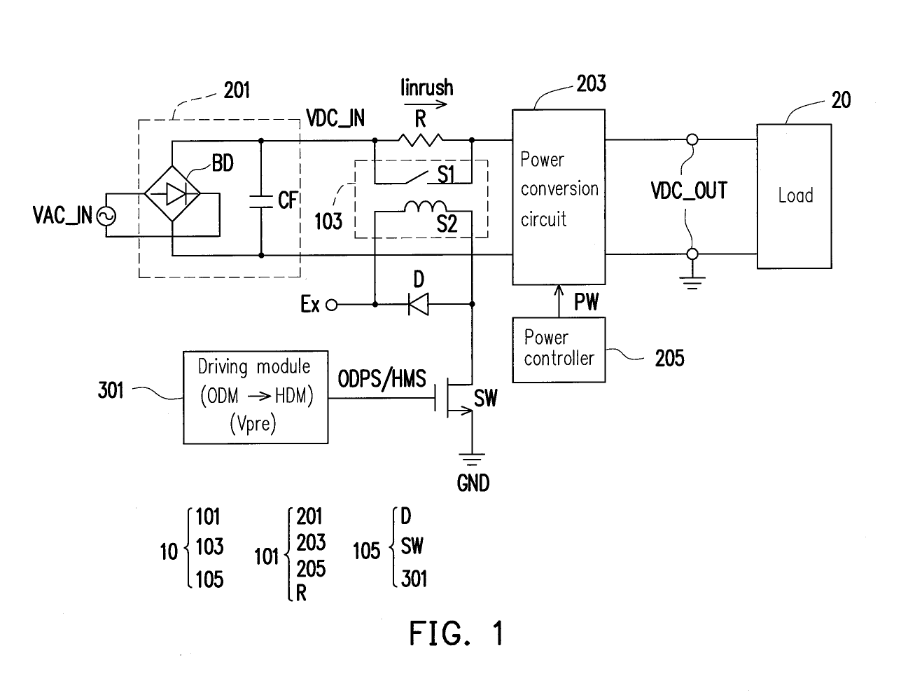

FIG. 1 is a diagram of a switching power supply apparatus 10 according to an exemplary embodiment of the invention. Referring to FIG. 1, the switching power supply apparatus 10 includes an AC-to-DC conversion circuit 101, a hysteretic relay 103 and a relay control circuit 105.

In this exemplary embodiment, the AC-to-DC conversion circuit 101 includes a current limit resistor R, a rectification-filtering unit 201, a power conversion circuit 203 and a power controller 205.

The current limit resistor R is configured to suppress an inrush current Iinrush generated during the AC-to-DC conversion circuit 101 converts an AC input voltage VAC_IN into a DC output voltage VDC_OUT, where the inrush current Iinrush may be the extremely large inrush current generated during the switching power supply apparatus 10 is in the startup state, but not limited thereto.

The rectification-filtering unit 201 may be composed of a bridge rectifier BD and a filtering capacitor CF, but not limited thereto. The rectification-filtering unit 201 is configured to receive the AC input voltage VAC_IN, and perform rectifying and filtering operation on the received AC input voltage VAC_IN respectively through the bridge rectifier BD and the filtering capacitor CF, so as to provide a DC input voltage VDC_IN.

The power conversion circuit 203 may be a boost DC conversion circuit, a buck DC conversion circuit, a boost-buck DC conversion circuit, a flyback DC conversion circuit, or a forward DC conversion circuit, but not limited thereto. The power conversion circuit 203 is configured to receive the DC input voltage VDC_IN from the rectification-filtering unit 201 through the current limit resistor R, and convert (i.e. DC-to-DC convert) the received DC input voltage VDC_IN in response to a pulse width modulation signal PW from the power controller 205, so as to output the DC output voltage VDC_OUT.

The power controller 205 is coupled to the power conversion circuit 203, and is configured to generate the pulse width modulation signal PW in response to a power supply request of a load 20 (for example, an electronic device, but not limited thereto), so as to control the operation of the power conversion circuit 203. In this exemplary embodiment, the power controller 205 is at least capable of pulse-width-modulating and power-factor-correcting.

The hysteretic relay 103 is coupled with the current limit resistor R in parallel. To be specific, the hysteretic relay 103 has a switch side S1 and an excitation side S2, wherein the switch side S1 of the hysteretic relay 103 is coupled with the current limit resistor R in parallel.

The relay control circuit 105 is coupled to the AC-to-DC conversion circuit 101 and the hysteretic relay 103, and is configured to control the hysteretic relay 103 to turn on in response to one of an over drive pulse signal ODPS and a holding modulation signal HMS when the DC output voltage VDC_OUT reaches to a certain predetermined value (for example, Vpre), so as to bypass the current limit resistor R. It is noted that an enabling time of the over drive pulse signal ODPS is different from that of the holding modulation signal HMS, for example, the enabling time of the over drive pulse signal ODPS is substantially greater than that of the holding modulation signal HMS.

In this exemplary embodiment, the relay control circuit 105 includes a diode D, a switch SW and a driving module 301.

The diode D is coupled with the excitation side S2 of the hysteretic relay 103 in parallel, and a cathode of the diode D is coupled to an excitation power source Ex. In this exemplary embodiment, the reverse current is avoided by the diode D.

A first terminal of the switch SW is coupled to an anode of the diode D, a second terminal of the switch SW is coupled to a ground potential GND, and a control terminal of the switch SW is configured to receive one of the over drive pulse signal ODPS and the holding modulation signal HMS from the driving module 301.

The driving module 301 is coupled to the switch SW, and is configured to enter, when the DC output voltage VDC_OUT reaches to the predetermined value Vpre, into an over drive mode ODM, so as to generate the over drive pulse signal ODPS to drive the switch SW. After the over drive pulse signal ODPS is generated, the driving module 301 is further configured to enter into a holding drive mode HDM from the over drive mode ODM, so as to generate the holding modulation signal HMS to drive the switch SW.

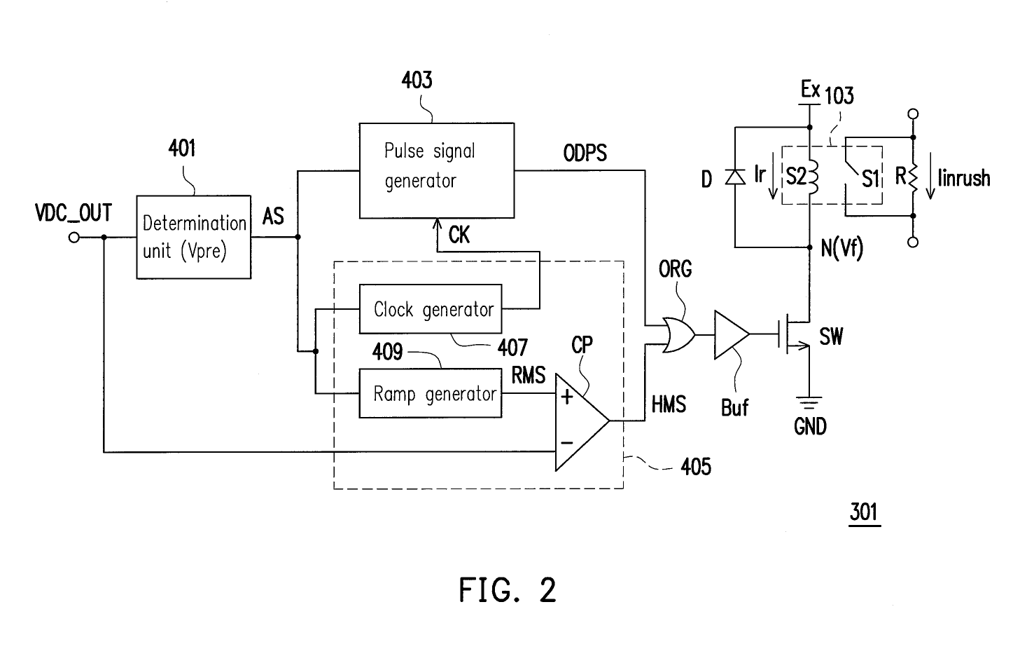

To be specific, FIG. 2 is a diagram of the driving module 301 in FIG. 1. Referring to FIGS. 1 and 2, the driving module 301 includes a determination unit 401, a pulse signal generator 403, a modulation signal generator 405, an OR gate ORG and a buffer Buf.

The determination unit 401 is configured to receive and determine whether the DC output voltage VDC_OUT from the AC-to-DC conversion circuit 101 reaches to the predetermined value Vpre, and provide an activation signal AS in case that the DC output voltage VDC_OUT reaches to the predetermined value Vpre.

The pulse signal generator 403 is coupled to the determination unit 401, and is configured to operate under a clock signal CK in response to the activation signal AS, so as to generate the over drive pulse signal ODPS.

The modulation signal generator 405 is coupled to the determination unit 401 and the pulse signal generator 403, and is configured to provide the clock signal CK and a ramp signal RMS in response to the activation signal AS. The modulation signal generator 405 is further configured to adjust and generate the holding modulation signal HMS under a voltage-second balance principle in response to a comparison of the DC output voltage VDC_OUT and the ramp signal RMS.

In this exemplary embodiment, the modulation signal generator 405 includes a clock generator 407, a ramp generator 409 and a comparator CP. The clock generator 407 is configured to provide the clock signal CK in response to the activation signal AS from the determination unit 401. The ramp generator 409 is configured to provide the ramp signal RMS in response to the activation signal AS from the determination unit 401. A positive input terminal (+) of the comparator CP is configured to receive the ramp signal RMS from the ramp generator 409, a negative input terminal (−) of the comparator CP is configured to receive the DC output voltage VDC_OUT from the AC-to-DC conversion circuit 101, and an output terminal of the comparator CP is configured to output the holding modulation signal HMS.

A first input terminal of the OR gate ORG is configured to receive the over drive pulse signal ODPS from the pulse signal generator 403, and a second input terminal of the OR gate ORG is configured to receive the holding modulation signal HMS from the modulation signal generator 405.

An input terminal of the buffer Buf is coupled to an output terminal of the OR gate ORG, and an output terminal of the buffer Buf is configured to output one of the over drive pulse signal ODPS and the holding modulation signal HMS to the control terminal of the switch SW, so as to drive the switch SW. In this exemplary embodiment, when the buffer Buf outputs the over drive pulse signal ODPS to the control terminal of the switch SW, the driving module 301 is in the over drive mode ODM; moreover, when the buffer Buf outputs the holding modulation signal HMS to the control terminal of the switch SW, the driving module 301 is in the holding drive mode HDM.

From the above, when the determination unit 401 determines that the DC output voltage VDC_OUT from the AC-to-DC conversion circuit 101 does not reach to the predetermined value Vpre, it represents that the switching power supply apparatus 10 is in the startup state. In this case, since the determination unit 401 does not provide the activation signal AS to trigger the pulse signal generator 403 and the modulation signal generator 405, so the pulse signal generator 403 and the modulation signal generator 405 are all in the inactivated/disabled state. Accordingly, the switch SW is turned off, and the hysteretic relay 103 is also turned off. Under the condition of that the hysteretic relay 103 is turned off, the extremely large inrush current Iinrush, generated during the switching power supply apparatus 10 is in the startup state, is suppressed by the current limit resistor R.

On the other hand, when the determination unit 401 determines that the DC output voltage VDC_OUT from the AC-to-DC conversion circuit 101 reaches to the predetermined value Vpre, it represents that the switching power supply apparatus 10 is in the normal operation state. In this case, since the determination unit 401 would provide the activation signal AS to trigger the pulse signal generator 403 and the modulation signal generator 405, so the pulse signal generator 403 and the modulation signal generator 405 are all in the activated/enabled state. Accordingly, the driving module 301 would enter into the over drive mode ODM, so as to make the buffer Buf output the over drive pulse signal ODPS with larger enabling time to turn on the switch SW.

Meanwhile, in response to the turned on switch SW for a long time, the current provided by the excitation power source Ex would flow through the excitation side S2 of the hysteretic relay 103, and increase gradually. Once the excitation side S2 of the hysteretic relay 103 generates the sufficient magnetic force in response to the current provided by the excitation power source Ex, the switch side S1 of the hysteretic relay 103 would be turned on, so as to bypass the current limit resistor R. Obviously, when the switching power supply apparatus 10 is in the normal operation state, the current limit resistor R would not generate unnecessary power loss, and then the efficiency of the switching power supply apparatus 10 is improved or unaffected.

After the driving module 301 enters into the over drive mode ODM, the driving module 301 then enters into the holding drive mode HDM from the over drive mode ODM, so as to make the buffer Buf output the holding modulation signal HMS with smaller enabling time to intermittently/periodically turn on the switch SW. In response to the periodically turned on switch SW, the current (Ir) flowing through the excitation side S2 of the hysteretic relay 103 would be suppressed and, reduced. However, after the driving module 301 enters into the holding drive mode HDM, the switch side S1 of the hysteretic relay 103 is maintained in the turn-on state due to the hysteretic relay 103 itself has the characteristic of hysteresis, until the switching power supply apparatus 10 is turned off. Obviously, after the driving module 301 enters into the holding drive mode HDM, the power loss of the hysteretic relay 103 in operation can be reduced, and then the purpose of power-saving can be achieved.

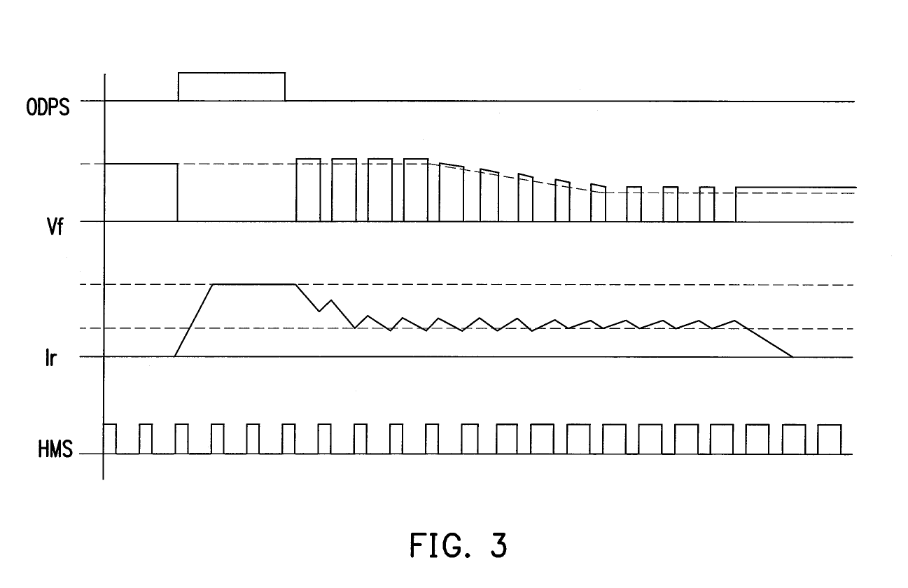

Herein, in order to avoid that the hysteretic relay 103 is turned off when the driving module 301 enters into the holding drive mode HDM from the over drive mode ODM, in this exemplary embodiment, the modulation signal generator 405 would adjust the duty cycle of the holding modulation signal HMS, as shown in FIG. 3, under the voltage-second balance principle in response to the comparison of the DC output voltage VDC_OUT from the AC-to-DC conversion circuit 101 and the ramp signal RMS from the ramp generator 409, so as to ensure that when the driving module 301 enters into the holding drive mode HDM from the over drive mode ODM, the hysteretic relay 103 is maintained in the turn-on state under the fixed energies. Specifically, the current (Ir) flowing the excitation side S2 of the hysteretic relay 103, the voltage (Vf) on the node N, the over drive pulse signal ODPS and the holding modulation signal HMS are shown on FIG. 3.

It is noted that, in the other exemplary embodiment, when the driving module 301 enters into the holding drive mode HDM from the over drive mode ODM, the modulation signal generator 405 may adjust the duty cycle of the holding modulation signal HMS under the voltage-second balance principle in response to the comparison of the excitation power source Ex and the ramp signal RMS from the ramp generator 409, so as to similarly ensure that when the driving module 301 enters into the holding drive mode HDM from the over drive mode ODM, the hysteretic relay 103 is maintained in the turn-on state under the fixed energies.

In summary, when the switching power supply apparatus 10 is in the startup state, namely, the DC output voltage VDC_OUT does not reach to the predetermined value Vpre, the inrush current Iinrush generated during the AC-to-DC conversion circuit 101 converts the AC input voltage VAC_IN into the DC output voltage VDC_OUT is suppressed by the current limit resistor R.

On the other hand, when the switching power supply apparatus 10 is in the normal operation state, namely, the DC output voltage VDC_OUT reaches to the predetermined value Vpre, the over drive pulse signal ODPS with larger enabling time is generated by the relay control circuit 105 to control the hysteretic relay 103 to turn on, such that the current limit resistor R is bypassed. Obviously, when the switching power supply apparatus 10 is in the normal operation state, the current limit resistor R would not generate unnecessary power loss, and then the efficiency of the switching power supply apparatus 10 is improved or unaffected.

Besides, after the current limit resistor R is bypassed, the holding modulation signal HMS with smaller enabling time is generated by the relay control circuit 105 to control the hysteretic relay 103 to continuously turn on, such that the power loss of the hysteretic relay 103 in operation is reduced, and then the purpose of power-saving can be achieved.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A switching power supply apparatus, comprising:
an AC-to-DC conversion circuit, comprising a current limit resistor, wherein the current limit resistor is configured to suppress an inrush current generated during the AC-to-DC conversion circuit converts an AC input voltage into a DC output voltage;
a hysteretic relay, coupled with the current limit resistor in parallel; and
a relay control circuit, coupled to the AC-to-DC conversion circuit and the hysteretic relay, configured to control the hysteretic relay to turn on in response to one of an over drive pulse signal and a holding modulation signal when the DC output voltage reaches to a predetermined value, so as to bypass the current limit resistor,
wherein an enabling time of the over drive pulse signal is different from that of the holding modulation signal.

2. The switching power supply apparatus according to claim 1, wherein the enabling time of the over drive pulse signal is substantially greater than that of the holding modulation signal.

3. The switching power supply apparatus according to claim 2, wherein:
the hysteretic relay has an excitation side and a switch side; and
the switch side of the hysteretic relay is coupled with the current limit resistor in parallel.

4. The switching power supply apparatus according to claim 3, wherein the relay control circuit comprises:
a diode, coupled with the excitation side of the hysteretic relay, and having a cathode coupled to an excitation power source;
a switch, having a first terminal coupled to an anode of the diode, a second terminal coupled to a ground potential, and a control terminal receiving one of the over drive pulse signal and the holding modulation signal; and
a driving module, coupled to the switch, configured to enter, when the DC output voltage reaches to the predetermined value, into an over drive mode, so as to generate the over drive pulse signal to drive the switch,
wherein after the over drive pulse signal is generated, the driving module is further configured to enter into a holding drive mode from the over drive mode, so as to generate the holding modulation signal to drive the switch.

5. The switching power supply apparatus according to claim 4, wherein the driving module comprises:
a determination unit, configured to receive and determine whether the DC output voltage reaches to the predetermined value, and provide an activation signal in case that the DC output voltage reaches to the predetermined value;
a pulse signal generator, coupled to the determination unit, configured to operate under a clock signal in response to the activation signal, so as to generate the over drive pulse signal;
a modulation signal generator, coupled to the determination unit and the pulse signal generator, configured to provide the clock signal and a ramp signal in response to the activation signal, wherein the modulation signal generator is further configured to adjust and generate the holding modulation signal under a voltage-second balance principle in response to a comparison of the DC output voltage and the ramp signal;
an OR gate, having a first input terminal receiving the over dive pulse signal, and a second input terminal receiving the holding modulation signal; and
a buffer, having an input terminal coupled to an output terminal of the OR gate, and an output terminal outputting one of the over drive pulse signal and the holding modulation signal to the control terminal of the switch.

6. The switching power supply apparatus according to claim 5, wherein the modulation signal generator comprises:
a clock generator, configured to provide the clock signal in response to the activation signal;
a ramp generator, configured to provide the ramp signal in response to the activation signal; and
a comparator, having a positive input terminal receiving the ramp signal, a negative input terminal receiving the DC output voltage, and an output terminal outputting the holding modulation signal.

7. The switching power supply apparatus according to claim 5, wherein:
when the buffer outputs the over drive pulse signal to the control terminal of the switch, the driving module is in the over drive mode; and
when the buffer outputs the holding modulation signal to the control terminal of the switch, the driving module is in the holding drive mode.

8. The switching power supply apparatus according to claim 1, wherein the AC-to-DC conversion circuit further comprises:
a rectification-filtering unit, configured to receive the AC input voltage, and perform rectifying and filtering operation on the AC input voltage, so as to provide a DC input voltage;
a power conversion circuit, configured to receive the DC input voltage through the current limit resistor, and convert the DC input voltage in response to a pulse width modulation signal, so as to output the DC output voltage; and
a power controller, coupled to the power conversion circuit, configured to generate the pulse width modulation signal in response to a power supply request of a load, so as to control operation of the power conversion circuit.

9. The switching power supply apparatus according to claim 8, wherein the rectification-filtering unit comprises a combination of a bridge rectifier and a filtering capacitor.

10. The switching power supply apparatus according to claim 8, wherein the power conversion circuit comprises a boost DC conversion circuit, a buck DC conversion circuit, a boost-buck DC conversion circuit, a flyback DC conversion circuit, or a forward DC conversion circuit.
